(19) United States
(12) Patent Application Publication
(10) Pub. No.: US 2011/0264668 A1
(43) Pub. Date: Oct. 27, 2011

(54) Methods and Systems for Providing Secondary Indexing in a Multi-Tenant Database Environment

(75) Inventors: David Hacker, Arlington, VA (US); Jeffrey Bergan, San Francisco, CA (US); Utsavi Benani, Fremont, CA (US); Paul Burstein, San Francisco, CA (US); Jon Mark Dewey, Walnut Creek, CA (US)

(73) Assignee: salesforce.com, inc., San Francisco, CA (US)

(21) Appl. No.: 12/962,429

(22) Filed: Dec. 7, 2010

Related U.S. Application Data
(60) Provisional application No. 61/328,516, filed on Apr. 27, 2010.

(51) Int. Cl. G06F 17/30

(52) U.S. Cl. 707/746; 707/741; 707/E17.002

(57) ABSTRACT

Secondary indexing mechanisms are disclosed. A first index is created in a database environment. The index has a scope defined by a set of files that meet a pre-selected criteria. Second index generation is initiated. Te second index has the same scope as the first index. A first time period between initiation of the generation of the second index and completion of the second index is determined. The second index is swapped with the first index in an atomic swap operation. The indices may be generated for a multitenant database environment. Catch up indexing may be performed for the secondary index.

### CLAIM OF PRIORITY

This application claims the benefit of U.S. Provisional Patent Application 61/328,516, entitled Methods and Systems for Providing Secondary Indexing in a Multi-Tenant Database Environment, by David Hacker, et al., filed Apr. 27, 2010, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the current invention relates generally to indexing of information stored in a database. More particularly embodiments of the invention relate to techniques for secondary indexing in a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

In order to be useful, large collections of data must be searchable and/or effectively organized. One technique to improve data search and/or retrieval is indexing, which provides structure within which data may be organized or viewed to provide more efficient access to the data. Many indexing techniques exist each having associate advantages and disadvantages.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a block diagram of an environment in which an on-demand database service might be used.

FIG. 2 is a flow diagram of one embodiment for providing secondary indexing in a multi-tenant environment.

FIG. 3 is a block diagram of one embodiment of a secondary indexing agent.

FIG. 4 is a timing diagram of one embodiment of a technique for providing secondary indexing utilizing one or more message queues.

FIG. 5 is a block diagram of one embodiment of a multi-tenant environment.

### DETAILED DESCRIPTION

Throughout the description, various examples of indexes are provided. The following general descriptions of may be helpful in better understanding the more detailed embodiments set forth below. For example, multiple customers, organizations, subscribers, or users, each may have their own distinct collections of data, may make use of the multi-tenant database implementation for storing their data. In order to optimize searching and other functions, an “index” is provided for certain collections of data. For example, an index may be provided for all data associated with one particular customer, thus improving search capabilities for information within that customer's collection of data.

Systems and methods are provided herein for indexing of data in a multi-tenant database system. As used herein, a multi-tenant database system refers to those systems in which various elements of hardware and software of the database system may be shared by one or more customers. For example, a given application server may simultaneously process requests for a great number of customers, and a given database table may store rows for a potentially much greater number of customers.

### General Overview

In one embodiment, a multi-tenant database system utilizes tenant identifiers (IDs) within a multi-tenant environment to allow individual tenants to access their data while preserving the integrity of other tenant's data. In one embodiment, the multitenant database stores data for multiple client entities each identified by a tenant ID having one of one or more users associated with the tenant ID. Users of each of multiple client entities can only access data identified by a tenant ID associated with their respective client entity. In one embodiment, the multitenant database is a hosted database provided by an entity separate from the client entities, and provides on-demand and/or real-time database service to the client entities.

In the description that follows, various techniques will be provided that support secondary indexing for one or more tenants of a multi-tenant database. It is useful to provide infrastructure and tools for a secondary indexing system that allow for full re-indexing of organizations and/or multi-tenant database instances in the background while production indexing and querying proceeds. The new indexes may then be swapped in for the old indexes using, for example, an atomic swap operation. In one embodiment, each multi tenant db instance has at least one indexing host that can write to the location where indexes are stored, to be used and queried against.

Some features described herein may allow organizations to be indexed in a different format or with additional information for each indexed record. In one embodiment, a secondary indexing system may be utilized to do the re-indexing with little to no interruption of primary indexing.

In one embodiment, a secondary index host may be provided in each instance of a multi-tenant database that may create the new index for organizations using local storage. In one embodiment, this host may be running what may be referred to as a secondary indexer, which may be responsible for choosing which organizations to index and initiate indexing of the organization.

In one embodiment, once indexing of an organization or instance is complete, work is queued from replay logs to make necessary changes to the index. In one embodiment, a replay log is a log of what indexing work has been completed by the primary indexer. The replay log(s) may be stored within the database. The replay log(s) allow indexing to be maintained without regressions.

In one embodiment, this is repeated until the index is either completely caught up, meaning there are no other entries to play back, or the index is within a certain delta of current time (e.g., one hour, 15 minutes, 2 hours). In either case, the index may be copied over to the primary host. In one embodiment, replay logs may be utilized again to completely catch the index up to current time or a pre-selected threshold time delta, and then an index switchover may be performed. At this point the new index may be used.

In the description provided herein, numerous specific details are set forth such as examples of specific systems, languages, components, etc., in order to provide a thorough understanding of the various embodiments. It will be apparent, however, to one skilled in the art that these specific details need not be employed to practice the disclosed embodiments. In other instances, well known materials or methods have not been described in detail in order to avoid unnecessarily obscuring the description.

### System Overview

The system descriptions that follow provide an example of a multi-tenant database environment in which secondary indexing techniques described herein may be utilized. As discussed above, multiple hosts are utilized and a strategy to determine whether to run the primary indexing service or the secondary indexing service on each indexing host is necessary. In one embodiment, the system may detect how the storage devices (e.g., SAN, or Storage Area Network, NAS, or Network Attached Storage) are mounted to the indexing host. In one embodiment, if it is read-only or not mounted, then the secondary indexing service is run and if it is read/write then the primary indexing service is run. In one embodiment, an alert is triggered when there is no primary indexer running in the instance. In another embodiment, secondary indexing may be directly configured, for example, by a system administrator or other user.

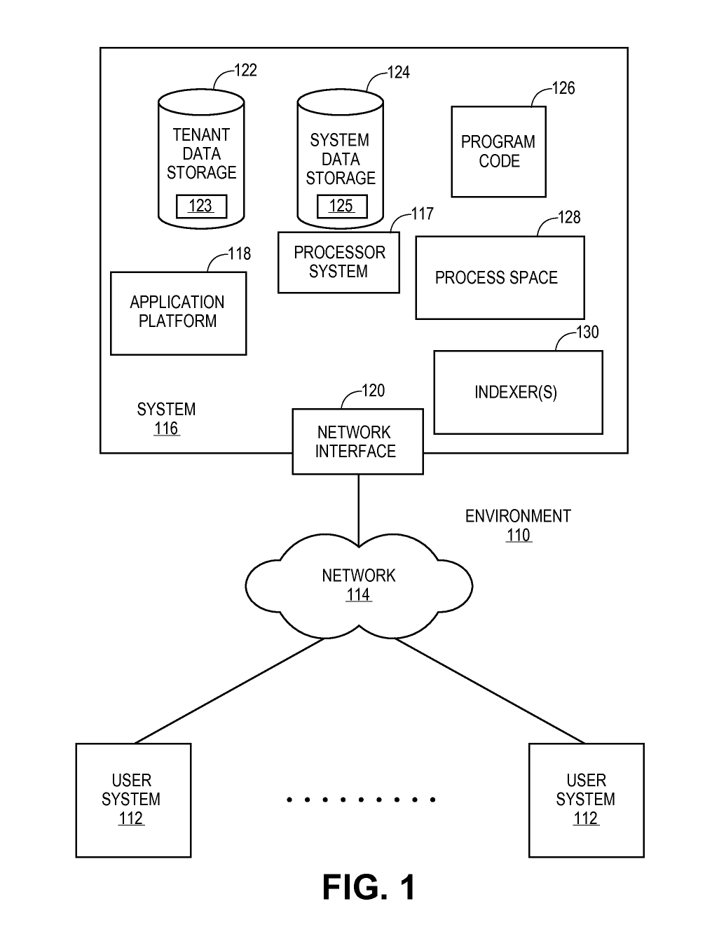

FIG. 1 is a block diagram of an environment in which an on-demand database service might be used. Environment 110 may include user systems 112, network 114, system 116, processor system 117, application platform 118, network interface 120, tenant data storage 122, system data storage 124, program code 126, and process space 128. In other embodiments, environment 110 may not have all of the components listed and/or may have other elements instead of, or in addition to, those listed above.

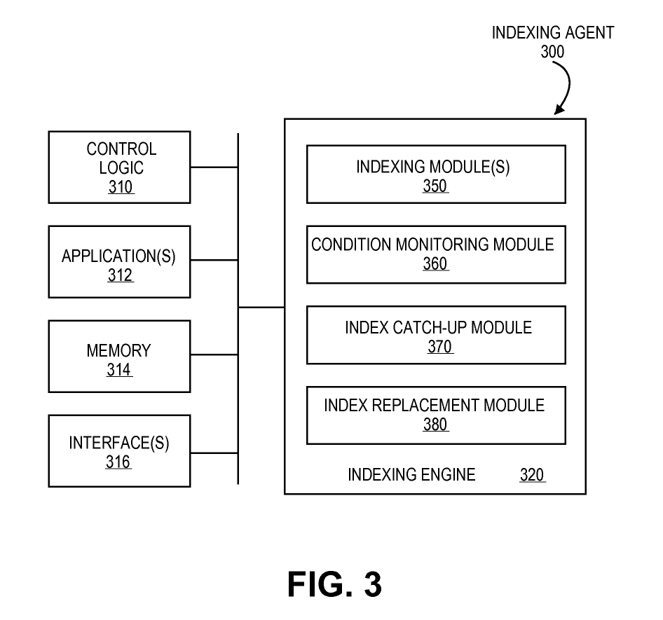

Environment 110 is an environment in which an on-demand database service exists. User system 112 may be any machine or system that is used by a user to access a database user system. For example, any of user systems 112 can be a handheld computing device, a mobile phone, a laptop computer, a work station, and/or a network of computing devices. As illustrated in FIG. 1 (and in more detail in FIG. 3) user systems 112 might interact via a network 114 with an on-demand database service, which is system 116.

An on-demand database service, such as system 116, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 116” and “system 116” will be used interchangeably herein.

A database image may include one or more database objects. A relational database management system (RDMS) or the equivalent may execute storage and retrieval of information against the database object(s). Application platform 118 may be a framework that allows the applications of system 116 to run, such as the hardware and/or software, e.g., the operating system. In an embodiment, on-demand database service 116 may include an application platform 118 that enables creation, managing and executing one or more applications developed by the provider of the on-demand database service, users accessing the on-demand database service via user systems 112, or third party application developers accessing the on-demand database service via user systems 112.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. Indexer(s) 130 may include one or more primary indexers and one or more secondary indexers that operate as described herein.

One arrangement for elements of system 116 is shown in FIG. 1, including network interface 120, application platform 118, tenant data storage 122 for tenant data 123, system data storage 124 for system data 125 accessible to system 116 and possibly multiple tenants, program code 126 for implementing various functions of system 116, and a process space 128 for executing MTS system processes and tenant-specific processes, such as running applications as part of an application hosting service.

Several elements in the system shown in FIG. 1 include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 116 or other systems or servers.

The user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a processing unit such as processor system 117, which may include an Intel Pentium® processor or the like, and/or multiple processor units.

A computer program product embodiment includes a machine-readable storage medium (media) having instructions stored thereon/in which can be used to program a computer to perform any of the processes of the embodiments described herein. Computer code for operating and configuring system 116 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 116 is configured to provide webpages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B).

As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

### Example Indexing Techniques

In one embodiment, there are three index processes that run on the primary host. One index process (Indexer) handles incremental updates typically from triggers and takes the highest priority; a second index process (Bulk Indexer) handles indexing large amounts of data like long running re-indexing tasks. The final indexer (Offload Indexer) handles offloaded indexing tasks.

In another embodiment, asynchronous messaging (e.g., messaging queues) may be utilized to manage secondary indexing. For example, replay logs or other tracking mechanisms may be used to determine what indexing work there should be done and to manage the indexing work. One advantage of using the message queue(s) is that information about indexing work to be done is pushed, rather than requiring constant polling in order to determine if there is indexing work to do. Messaging queues also simplify horizontal scaling because messages can be forced to only be processed on selected hosts. In alternate embodiments, different indexer process configurations may be utilized.

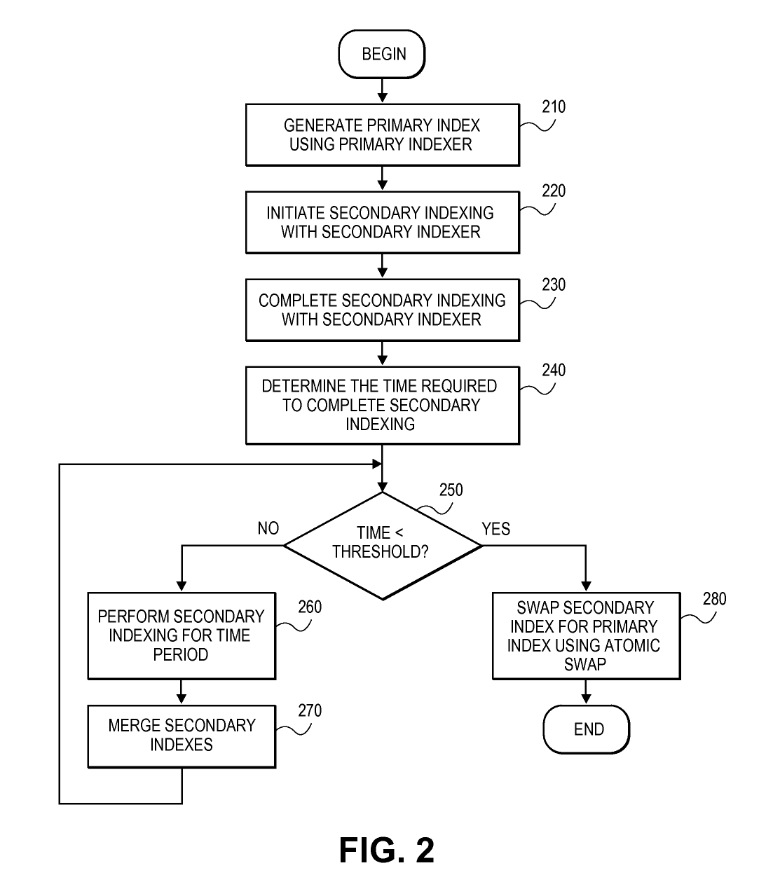

FIG. 2 is a flow diagram of one embodiment for providing secondary indexing in a multi-tenant environment. The secondary indexer(s) may be configured to operate until a pre-selected set of conditions is met. When those conditions are met, the newly created index can be swapped with the older index to be replaced. This allows for real-time, or near real-time, indexing of changing data sets. As discussed above, the indexing techniques described herein may be applied to multi-tenant database environments.

In one embodiment, different hosts within a multi-host, multi-tenant database environment perform primary indexing and secondary indexing. In one embodiment, a secondary (or backup index) host exists within each database instance and the new index is created for the organizations using local storage. In one embodiment, the host runs a Secondary Indexer, which is responsible for choosing which organizations to index and initiate indexing of the organization.

In one embodiment, once indexing of an organization (or instance) is complete, queuing work is started based on replay logs and these logs are used to make any changes to the secondary index that are necessary to make the index current. In one embodiment, the secondary indexer can repeat this until the secondary indexer is either completely caught up (e.g., there are no other entries to play back), or the secondary indexer is within a certain delta of current time. In one embodiment, when a pre-selected set of conditions indicates that the secondary index is considered current (e.g., either within the predetermined delta, or empty replay log), it is swapped with the primary index on the primary host. In one embodiment, the replay logs may be utilized to completely catch the new primary index up to current times and then do an index switchover, and start using the new index.

A primary index is created with a primary indexer, 210. The primary index can be an initial index, or a previously generated index using the techniques described herein. In one embodiment, a primary indexer on a primary index host generates the primary index. That is, the primary index may be generated by a different entity than creates the secondary index. The primary index may be stored in a location is pre-selected for the primary index so that the primary index is easily accessible.

At some point after the primary index has been completed and is available, creation of the secondary index is initiated, 220. In one embodiment, a secondary indexer on a secondary indexing host generates the secondary index. In one embodiment, if the SAN is read only or not mounted, then a secondary indexing service provides the secondary index, and if the SAN is read/write then the primary indexing service provides the secondary index. In one embodiment, an alert is triggered when there is no primary indexer running in the instance.

After some period of time, the secondary indexer completes the indexing task and generates a resulting secondary index, 230. In one embodiment, at this stage, the secondary index is an index of files that existed at the time the secondary index was initiated (e.g., 220). That is, files may have been created and/or modified that exist in the multi-tenant database environment that are not accurately reflected in the secondary index. These files correspond to creation and/or modification between the initiation of the secondary index and the completion of the secondary index.

The secondary indexer (or other system component) determines the time required to complete the secondary indexing, 240. In one embodiment, this is the time between initiation of the secondary indexing and completion of the secondary indexing; however, other relevant time periods may also be used. The time required for the secondary indexing is compared to a threshold value, 250. The threshold value can be a period for which no coverage by the secondary index is acceptable (e.g., one hour, 12 hours, one day, 30 minutes). Other parameters and/or conditions may also be used, for example, a number of files unindexed, an amount of storage area unindexed, etc.

If the time (or other condition/conditions) satisfies the pre-selected threshold, 250, the secondary index may be swapped with the primary index. In one embodiment, the primary-secondary index swap is performed with an atomic swap operation. After the swap, the newly created secondary index becomes the primary index and is used by the system as the primary index. It can be maintained and/or managed by the primary indexer.

If the time (or other condition/conditions) does not satisfy the pre-selected threshold, 250, the secondary indexer performs indexing for that period of time, 260. In one embodiment, replay logs are utilized to determine the scope of this “catch-up” indexing. Upon completion of the catch-up indexing, the secondary index is updated to include this new indexing, 270. The process of catch-up indexing may be performed one or more times until the secondary index is sufficiently current as determined by the conditions described above, 250. At that point, the secondary index may be swapped with the primary index, 280.

In one embodiment, a copy service may be used for copying an index from a production instance to a sandbox instance. In one embodiment, the copy service clones the production instance (e.g., secondary) index into a clone directory and then copies it to a sandbox instance that stores the index in migration directory. After this is completed, the current (e.g., primary) index in a Normal directory is renamed (e.g., to have a “.bak” prefix/suffix), and the migration (e.g., secondary index) copy is moved into the Normal directory, the backup version is then deleted as soon as it is unused. In one embodiment, during the time that only the backup version of the index exists, query hosts will use it.

In one embodiment, after the secondary-primary index swap, additional catch-up indexing may be performed on the new primary index to provide a more current primary index than would otherwise be available with only a secondary-primary index swap. In one embodiment, the primary indexer performs the catch-up indexing on the primary index.

When configuring indexing services, one or more of the following parameters may be utilized: a maximum number of organizations that may be indexed locally; an organization metric type to be used; catch-up time and/or other conditions; a maximum storage space allotted to indexing; and/or a directory for local storage. Other parameters may also be utilized with configuring indexing services.

In one embodiment, there is there an organization value that determines the indexing and query policy. This is indicated by a pre-selected variable that is accessible by one or more indexing entities. In the example that follows, this variable is referred to as the “Search Indexing Policy” however, other names may also be used. In one embodiment, this will need to be updated at the completion of secondary indexing.

Alternatively, two variables “Search Query Policy” and “Secondary Search Indexing Policy” may be used. In this example, Search Indexing Policy may be the policy used by the primary indexer and Secondary Search Indexing Policy determines which policy to use while creating a new index on the secondary indexer and may be independent of Search Indexing Policy. In one embodiment, Search Query Policy may be added as there may be some time when the primary index has been converted to the new indexing policy but access to query the old index using the old policy should be maintained.

In one embodiment, if there is no query policy the search indexing policy may be used. In one embodiment, when an organization is enqueued to be indexed by the secondary indexer, the secondary indexing policy will be set accordingly. Once this is complete and the copy is finished, an organization lock is used to change the secondary query policy to be the current primary indexing policy and to query the backup index. The primary indexing policy may be set to the secondary indexing policy. At this point, jobs may be enqueued and the end of the batch can be indicated to cause the old index to be deleted and the query policy to be updated.

FIG. 3 is a block diagram of one embodiment of a secondary indexing agent. Indexing agent 300 includes control logic 310, which implements logical functional control to direct operation of indexing agent 300, and/or hardware associated with directing operation of indexing agent 300. Logic may be hardware logic circuits and/or software routines. In one embodiment, indexing agent 300 includes one or more applications 312, which represent code sequence and/or programs that provide instructions to control logic 310.

Indexing agent 300 includes memory 314, which represents a memory device and/or access to a memory resource for storing data and/or instructions. Memory 314 may include memory local to indexing agent 300, as well as, or alternatively, including memory of the host system on which indexing agent 300 resides. Indexing agent 300 also includes one or more interfaces 316, which represent access interfaces to/from (an input/output interface) indexing agent 300 with regard to entities (electronic or human) external to indexing agent 300.

Indexing agent 300 also includes indexing engine 320, which represents one or more functions or module that enable indexing agent 300 to provide the indexing services as described above. The example of FIG. 3 provides several modules that may be included in indexing engine 320; however, different and/or additional modules may also be included. Example modules that may be involved in providing the indexing functionality include indexing module(s) 350, condition monitoring module 360, index catch-up module 370 and index replacement module 380. Each of these modules may further include other sub-modules to provide other functions. As used herein, a module refers to routine, a subsystem, logic circuit, microcode, etc., whether implemented in hardware, software, firmware or some combination thereof.

Indexing module(s) 350 providing the indexing services described above. In one embodiment, indexing agent 300 operates as the secondary indexer described above. In such an embodiment, indexing module 350 operates to provide the secondary index. In one embodiment, the indexing module 350 operates according to the flow diagram of FIG. 2 to provide the secondary index.

Condition monitoring module 360 may monitor conditions associated with generating indexes with indexing agent 300. For example, in one embodiment, condition monitoring module 360 may determine the time required to generate a secondary index in order to determine a time period for which catch-up indexing may be performed. Condition monitoring agent 360 may also monitor other conditions relevant to indexing. For example, condition monitoring agent 360 may monitor memory usage and/or available memory space, and/or condition monitoring agent 360 may monitor directories to be used, etc.

Index catch-up module 370 may manage catch-up indexing based on the indexes generated by indexing module and conditions as determined by condition monitoring module 360. Index catch-up module 370 may cause indexing module(s) 350 to perform catch-up indexing.

Index replacement module 380 may function to cause the index generated by indexing module(s) 350 to replace a primary index in the manner described above. Indexing engine 320 and indexing agent 300 may support additional and/or different modules and functionality. Indexing engine 320 and indexing agent 300 may support any number of modules.

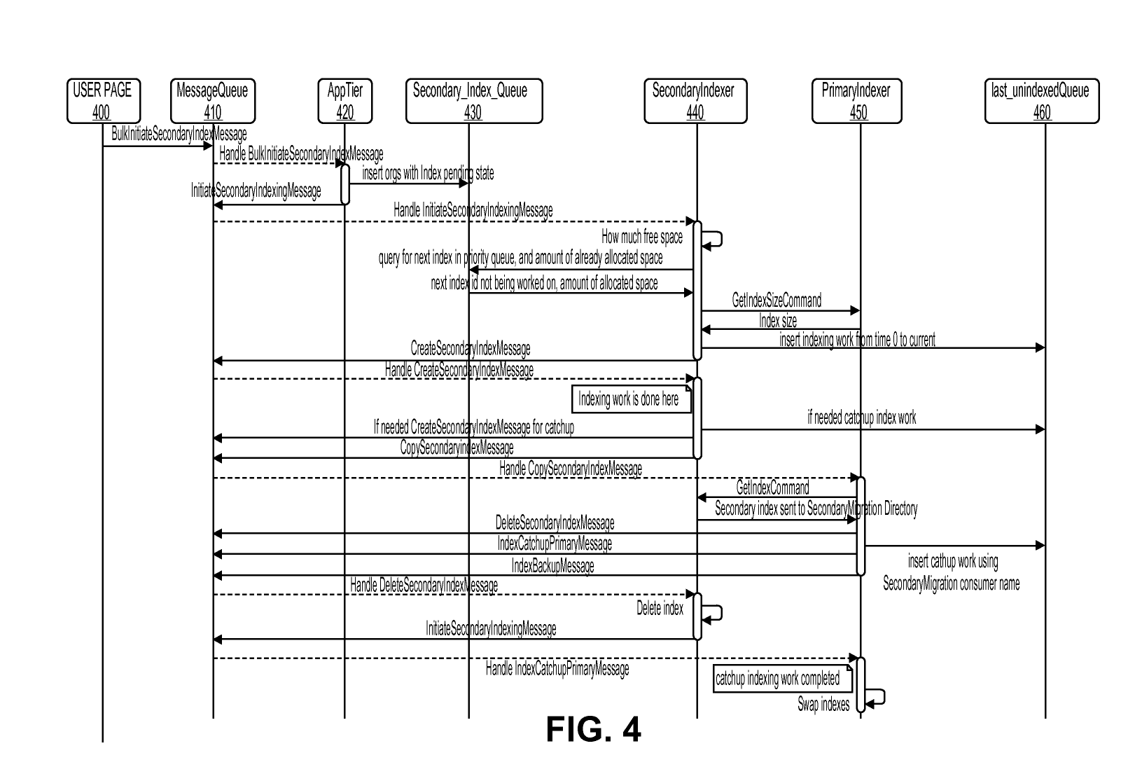

FIG. 4 is a timing diagram of one embodiment of a technique for providing secondary indexing utilizing one or more message queues. The example of FIG. 4 provides specific messages and a specific message flow; however, alternate message types as well as alternate message flows may also be utilized to provide the functionality described herein. That is, the claims should not be limited to the specific message recited in FIG. 4. The messaging structure as described with respect to FIG. 4 may allow secondary indexers to perform secondary indexing as soon as they have space available that may be allocated to that corresponding organization.

In one embodiment, User Page 400 provides an interface to allow a user access to various features of the multitenant environment. In one embodiment, indexing control is limited to certain users, for example, system administrators. User Page 400, either as the result of an explicit command, or a set of pre-selected conditions, may send a message to initiate secondary indexing (e.g., BulkInitiateSecondaryIndexMessage).

In one embodiment, User Page 400 causes the secondary index initiation message to be placed in Message Queue 410, which maintains indexing messages. Messaging Queue 410 may also store and/or manage other types of messages as well. In one embodiment, Messaging Queue 410 forwards a message (e.g., Handle BulkInitiateSecondaryIndexMessage) to one or more applications or application managers (AppTier) 420 to effect the initiation of secondary indexing. AppTier 420 may respond to Message Queue 410 by providing a message indicating that the requested secondary indexing has been initiated.

In one embodiment, AppTier 420 causes to be inserted in Secondary Index Queue 430, an indication of one or more organizations within the multitenant environment for which secondary indexing should be performed. Message Queue 410 may also send a message (e.g., Handle BulkInitiateSecondaryIndexMessage) to Secondary Indexer 440. Secondary Indexer 440 may provide indexing services as described herein.

In one embodiment, Secondary Indexer 440 determines whether sufficient memory is available to complete a secondary indexing operation. If sufficient memory is available, Secondary Indexer 440 may query Secondary Index Queue 430 for a next indexing job and/or provide an indication of memory available for indexing work. Secondary Indexing Queue 430 may provide an identifier corresponding to data to be indexed and/or an amount of memory that may be needed to complete the requested indexing.

In response to receiving the identifier from Secondary Indexing Queue 430, Secondary Indexer 440 may request (e.g., GetIndexSizeCommand), from Primary Indexer 450, a size of the corresponding primary index. Primary Indexer 450 may provide to Secondary Indexer 440 the size of the index. In one embodiment, Secondary Indexer 440 causes indexing work performed up to the time of initiation of secondary indexing to be stored in Last Indexed Queue 460.

Secondary Indexer 440 may send a message (e.g., CreateSecondaryIndexMessage) to Message Queue 410. Message Queue 410 may handle the message by triggering secondary indexing by Secondary Indexer 440. Secondary Indexer 440 may then perform secondary indexing as described herein. When secondary indexing is completed by Secondary Indexer 440, catch up indexing may be performed.

In one embodiment, a secondary indexing message (e.g., CreateSecondaryIndexMessage) may be created for catch up indexing and sent from Secondary Indexer 440 to Message Queue 410. When the secondary indexing work is completed (including catch up indexing, if necessary), Secondary Indexer 440 may send a message (e.g., CopySecondaryIndexMessage) to Message Queue 410 to cause the secondary index to be copied, as described above.

In one embodiment, the index copy message in Message Queue 410 may cause Primary Indexer 450 to send a message (e.g., GetIndexCommand) to Secondary Indexer 440 to request a copy of the secondary index. In one embodiment, the request for the index copy causes Secondary Indexer 440 to send the secondary index file to a Secondary Migration Directory (not illustrated in FIG. 4), from which it may be copied.

In one embodiment, after the secondary index has been copied, Primary Indexer 450 may send a message (e.g., DeleteSecondaryIndexMessage) to Message Queue 410 to cause the secondary index to be deleted. Primary Indexer 450 may also perform catch up indexing on the newly copied secondary index file. As part of the catch up indexing, Primary Indexer 450 may send a message (e.g., IndexCatchupPrimaryMessage) to Message Queue 410. Primary Indexer 450 may also send a message (e.g., IndexBackupMessage) to Message Queue 410 cause subsequent secondary indexing.

Message Queue 410 may transmit to Secondary Indexer 440 a message (e.g., DeleteSecondaryIndexMessage) to cause Secondary Indexer 440 to delete the secondary index. In response to deleting the secondary index, Secondary Indexer 440 may send a message (e.g., InitiateSecondaryIndexingMessage) to Message Queue 410 to initiate subsequent secondary indexing.

Message Queue 410 may send a message (e.g., IndexCatchupPrimaryMessage) to Primary Indexer 450 to cause Primary Indexer 450 to perform catch up indexing on the secondary index. When the catch up indexing has been completed, Primary Indexer 450 may swap the newly generated and caught up secondary index file for the previously used primary index file.

### Example System

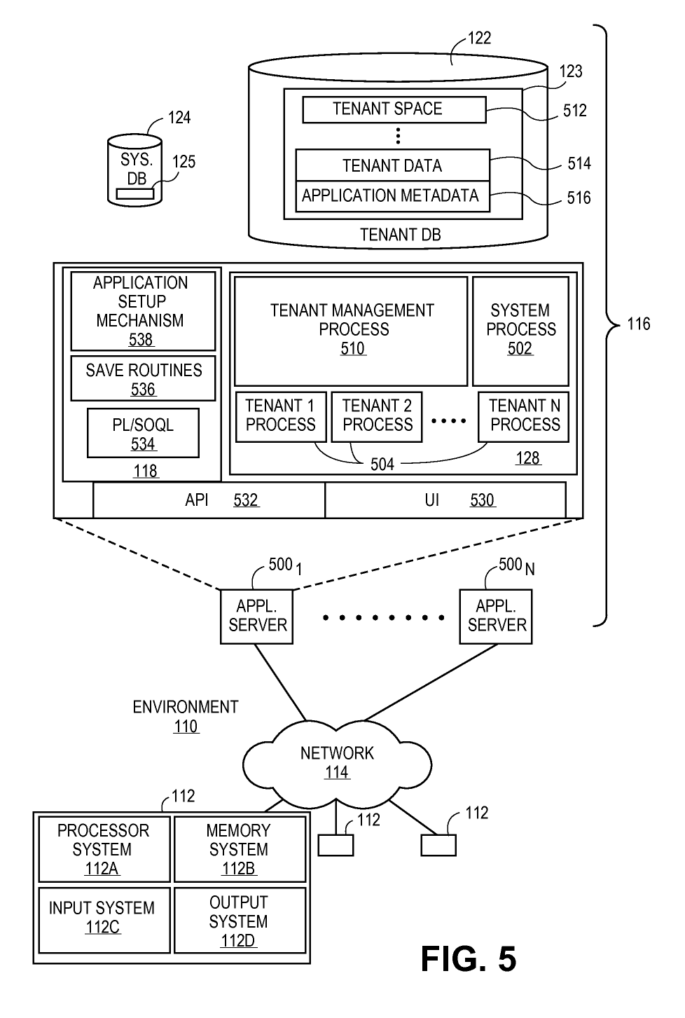

In FIG. 5 elements of system 116 and various interconnections in an embodiment are further illustrated. FIG. 5 shows that user system 112 may include processor system 112A, memory system 112B, input system 112C, and output system 112D. FIG. 5 shows network 114 and system 116. FIG. 5 also shows that system 116 may include tenant data storage 122, tenant data 123, system data storage 124, system data 125, User Interface (UI) 530, Application Program Interface (API) 532, PL/SOQL 534, save routines 536, application setup mechanism 538, applications servers 500₁-500_{N}, system process space 502, tenant process spaces 504, tenant management process space 510, tenant storage area 512, user storage 514, and application metadata 516. In other embodiments, environment 110 may not have the same elements as those listed above and/or may have other elements instead of, or in addition to, those listed above.

User system 112, network 114, system 116, tenant data storage 122, and system data storage 124 were discussed above in FIG. 1. Regarding user system 112, processor system 112A may be any combination of one or more processors. Memory system 112B may be any combination of one or more memory devices, short term, and/or long term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks.

System 116 may include a network interface 120 implemented as a set of HTTP application servers 500, an application platform 118, tenant data storage 122, and system data storage 124. Also shown is system process space 502, including individual tenant process spaces 504 and a tenant management process space 510. Each application server 500 may be configured to tenant data storage 122 and the tenant data 123 therein, and system data storage 124 and the system data 125 therein to serve requests of user systems 112. The tenant data 123 might be divided into individual tenant storage areas 512, which can be either a physical arrangement and/or a logical arrangement of data.

Within each tenant storage area 512, user storage 514 and application metadata 516 might be similarly allocated for each user. For example, a copy of a user's most recently used (MRU) items might be stored to user storage 514. Similarly, a copy of MRU items for an entire organization that is a tenant might be stored to tenant storage area 512. A UI 530 provides a user interface and an API 532 provides an application programmer interface to system 116 resident processes to users and/or developers at user systems 112. The tenant data and the system data may be stored in various databases, such as one or more Oracle™ databases.

Application platform 118 includes an application setup mechanism 538 that supports application developers' creation and management of applications, which may be saved as metadata into tenant data storage 122 by save routines 536 for execution by subscribers as one or more tenant process spaces 504 managed by tenant management process 510, for example. Invocations to such applications may be coded using PL/SOQL 534 that provides a programming language style interface extension to API 532. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 516 for the subscriber making the invocation and executing the metadata as an application in a virtual machine.

Each application server 500 may be communicably coupled to database systems, e.g., having access to system data 125 and tenant data 123, via a different network connection. For example, one application server 500₁ might be coupled via the network 114 (e.g., the Internet), another application server 500_{N-1} might be coupled via a direct network link, and another application server 500N might be coupled by yet a different network connection. Transfer Control Protocol and Internet Protocol (TCP/IP) are typical protocols for communicating between application servers 500 and the database system. However, other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there may no server affinity for a user and/or organization to a specific application server 500. In one embodiment, therefore, an interface system implementing a load balancing function (e.g., an F5 Big-IP load balancer) is communicably coupled between the application servers 500 and the user systems 112 to distribute requests to the application servers 500.

In one embodiment, the load balancer uses a least connections algorithm to route user requests to the application servers 500. Other examples of load balancing algorithms, such as round robin and observed response time, also can be used. For example, in certain embodiments, three consecutive requests from the same user could hit three different application servers 500, and three requests from different users could hit the same application server 500. In this manner, system 116 is multi-tenant, wherein system 116 handles storage of, and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 500 to request and update system-level and tenant-level data from system 116 that may require sending one or more queries to tenant data storage 122 and/or system data storage 124. System 116 (e.g., an application server 500 in system 116) automatically generates one or more SQL statements (e.g., one or more SQL queries) that are designed to access the desired information. System data storage 124 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema.

Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### CONCLUSION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method comprising:
creating a first index in a database environment, the index having a scope defined by a set of files that meet a pre-selected criteria;
initiating generation of a second index with a secondary indexer, the second index having the same scope as the first index;
determining a first time period between initiation of the generation of the second index and completion of the second index; and
swapping the second index with the first index in an atomic swap operation.

2. The method of claim 1 wherein the database environment comprises a multitenant database environment, wherein the multitenant database environment stores data for multiple client entities each identified by a tenant identifier (ID) having one of one or more users associated with the tenant ID, wherein users of each of multiple client entities can only access data identified by a tenant ID associated with the respective client entity, and wherein the multitenant database is a hosted database provided by an entity separate from the client entities, and provides on-demand database service to the client entities.

3. The method of claim 2 wherein the second index has a tenant ID corresponding to the first index.

4. The method of claim 1 further comprising:
comparing the first time period to a pre-selected time threshold value;
performing indexing for the first time period, if the time period exceeds the pre-selected time threshold value to generate a catch-up index;
combining the second index and the catch-up index to generate an augmented second index, if the time period exceeds the pre-selected time threshold value to generate a catch-up index; and
swapping the augmented second index and the first index in an atomic swap operation, if the time period exceeds the pre-selected time threshold value to generate a catch-up index.

5. The method of claim 1 wherein swapping the second index with the first index in an atomic swap operation comprises:
cloning the second index into a clone directory;
moving the second index to a secure portion of memory;
renaming the first index;
moving the second index from the secure portion of memory to a directory corresponding to the first index with an original name for the first index; and
removing the renamed first index from the directory;
causing index queries to access the second index.

6. The method of claim 5 wherein, during a time period for which only the renamed first index exists within the directory corresponding to the first index, causing index queries to access the renamed first index.

7. The method of claim 3 wherein the first index and the second index correspond to a single tenant ID in the multitenant database environment.

8. The method of claim 3 wherein the first index and the second index correspond to multiple tenant IDs in the multitenant database environment.

9. An article of manufacture comprising a computer-readable medium, having stored therein instructions that, when executed, cause one or more processors to:
create a first index in a database environment, the index having a scope defined by a set of files that meet a pre-selected criteria;
initiate generation of a second index with a secondary indexer, the second index having the same scope as the first index;
determine a first time period between initiation of the generation of the second index and completion of the second index; and
swap the second index with the first index in an atomic swap operation.

10. The article of claim 9 wherein the database environment comprises a multitenant database environment, wherein the multitenant database environment stores data for multiple client entities each identified by a tenant identifier (ID) having one of one or more users associated with the tenant ID, wherein users of each of multiple client entities can only access data identified by a tenant ID associated with the respective client entity, and wherein the multitenant database is a hosted database provided by an entity separate from the client entities, and provides on-demand database service to the client entities.

11. The article of claim 10 wherein the second index has a tenant ID corresponding to the first index.

12. The article of claim 9 further comprising instructions that, when executed, cause the one or more processors to:
compare the first time period to a pre-selected time threshold value;
perform indexing for the first time period, if the time period exceeds the pre-selected time threshold value to generate a catch-up index;
combine the second index and the catch-up index to generate an augmented second index, if the time period exceeds the pre-selected time threshold value to generate a catch-up index; and
swap the augmented second index and the first index in an atomic swap operation, if the time period exceeds the pre-selected time threshold value to generate a catch-up index.

13. The article of claim 9 wherein the instructions that cause the one or more processors to swap the second index with the first index in an atomic swap operation comprise instructions that, when executed, cause the one or more processors to:
clone the second index into a clone directory;
move the second index to a secure portion of memory;
rename the first index;
move the second index from the secure portion of memory to a directory corresponding to the first index with an original name for the first index; and
remove the renamed first index from the directory;
cause index queries to access the second index.

14. The article of claim 13 wherein, during a time period for which only the renamed first index exists within the directory corresponding to the first index, causing index queries to access the renamed first index.

15. The article of claim 13 wherein the first index and the second index correspond to a single tenant ID in the multitenant database environment.

16. The article of claim 9 wherein the first index and the second index correspond to multiple tenant IDs in the multitenant database environment.

17. An apparatus comprising:
means for creating a first index in a database environment, the index having a scope defined by a set of files that meet a pre-selected criteria;
means for initiating generation of a second index with a secondary indexer, the second index having the same scope as the first index;
means for determining a first time period between initiation of the generation of the second index and completion of the second index; and
means for swapping the second index with the first index in an atomic swap operation.

18. The apparatus of claim 17 wherein the database environment comprises a multitenant database environment, wherein the multitenant database environment stores data for multiple client entities each identified by a tenant identifier (ID) having one of one or more users associated with the tenant ID, wherein users of each of multiple client entities can only access data identified by a tenant ID associated with the respective client entity, and wherein the multitenant database is a hosted database provided by an entity separate from the client entities, and provides on-demand database service to the client entities.

19. The apparatus of claim 18 wherein the second index has a tenant ID corresponding to the first index.

20. The apparatus of claim 17 further comprising:
means for comparing the first time period to a pre-selected time threshold value;
means for performing indexing for the first time period, if the time period exceeds the pre-selected time threshold value to generate a catch-up index;
means for combining the second index and the catch-up index to generate an augmented second index, if the time period exceeds the pre-selected time threshold value to generate a catch-up index; and
means for swapping the augmented second index and the first index in an atomic swap operation, if the time period exceeds the pre-selected time threshold value to generate a catch-up index.

21. The apparatus of claim 17 wherein the means for swapping the second index with the first index in an atomic swap operation comprises:
means for cloning the second index into a clone directory;
means for moving the second index to a secure portion of memory;
means for renaming the first index;
means for moving the second index from the secure portion of memory to a directory corresponding to the first index with an original name for the first index; and
means for removing the renamed first index from the directory;
means for causing index queries to access the second index.
